(19) United States
(12) Patent Application Publication
(10) Pub. No.: US 2017/0060271 A1
(43) Pub. Date: Mar. 2, 2017

(54) INPUT DEVICE

(71) Applicant: DENSO CORPORATION, Aichi (JP)

(72) Inventor: Shinsuke HISATSUGU, Kariya-city (JP)

(21) Appl. No.: 14/784,428

(22) PCT Filed: Apr. 15, 2014
(86) PCT No.: PCT/JP2014/002117

§ 371 Date: Oct. 14, 2015

(30) Foreign Application Priority Data
Apr. 25, 2013 (JP) 2013-092826

(51) Int. Cl. G06F 3/0362; H02K 41/035; G06F 3/0354

(52) U.S. Cl. CPC G06F 3/0362; G06F 3/0354; H02K 41/0356

(57) ABSTRACT

An input device includes four coil bodies held by a holder and four movable magnetic pole formation portions held by a movable body. The coil bodies are arranged two-by-two in x-axis and y-axis direction and arranged in a crisscross with a center region and four sides of the center region are surrounded by the four coil bodies. The magnetic pole formation portions are arranged two-by-two in the x-axis and y-axis directions so that the polarities alternately change. Each magnetic pole formation portion has a facing surface that faces two of the four coil bodies in a winding axis direction of the coil body. The movable body is arranged to be movable relative to the holder in response to receipt of an operation force.

### CROSS REFERENCE TO RELATED APPLICATION

This application is based on Japanese Patent Application No. 2013-92826 filed on Apr. 25, 2013, the disclosure of which is incorporated herein by reference.

### TECHNICAL FIELD

The present disclosure relates to an input device to which an operation force is inputted.

### BACKGROUND ART

As an actuator used for an input device, Patent Literature 1 discloses a structure including four magnets and four coils. The magnets are arranged such that the respective surfaces thereof facing the coils have alternate polarities and are held on a first yoke plate. The coils are arranged such that each coil faces two of the four magnets in a z-axis direction and held on a second yoke plate. The winding wire wound around each coil extends in an x-axis direction and a y-axis direction.

The second yoke plate is movable relative to the first yoke plate and is fixed to a tactile feeling presentation unit to which a user operation is input. In the structure, a current is applied to each of the winding wires to generate electromagnetic forces in the x-axis and y-axis directions between the individual coils and between the individual magnets. Thus, the input device allows a user to feel an operation reaction force of an arbitrary strength through the tactile feeling presentation unit.

In the structure disclosed in Patent Literature 1, respective distances over which the tactile feeling presentation unit and the second yoke plate can move (hereinafter referred to as “full stroke amounts”) in the x-axis and y-axis directions are defined in advance. When the second yoke plate is moved relative to the first yoke plate, if the coils protrude from the magnets facing the coils, the strengths of the generable electromagnetic forces between the individual coils and between the individual magnets decrease. To avoid such a situation, the size of each of the magnets is set larger than that of each of the coils on basis of the full stroke amounts of the second yoke plate in the individual axis directions. In such a structure, the full stroke amounts of the second yoke plate required in the individual axis directions should be ensured for each of the magnets. Accordingly, it has been difficult to reduce the length of each side of each magnet and reduce the size of each o magnet.

### PRIOR ART LITERATURE

### Patent Literature

Patent Literature 1: JP-3997872B

### SUMMARY OF INVENTION

An object of the present disclosure is to provide an input device in which the size of each magnetic pole formation portion, which may be a magnet, is reduced and also a sufficient strength is ensured for a generable electromagnetic force.

In a first aspect of the present disclosure, an input device to which an operation force in a direction along a virtual operation plane is inputted comprises four coil bodies, a holder, four magnetic pole formation portions and a movable body. Each coil body includes a winding wire to which a current is applied. The winding wire of each coil body is wound to form four sides extending in an x-axis direction and a y-axis direction each along the operation plane. The holder holds the coil bodies such that the coil bodies are arranged two by two in the x-axis and y-axis directions and are arranged in a crisscross with a center region and four sides of the center region are surrounded by the four coil bodies. Each magnetic pole formation portion has a quadrilateral shape. The quadrilateral shape of each magnetic pole formation portion is proximate to or substantially the same as a shape of each coil body. Each magnetic pole formation portion has a facing surface that faces two of the four coil bodies in a winding axis direction of the winding wire. The four magnetic pole formation portions are arranged two by two in the x-axis and y-axis directions such that the facing surfaces have alternate polarities. Electromagnetic forces are generated between the four magnetic pole formation portions and the coil bodies when the currents are applied to the winding wires. The movable body holds the four magnetic pole formation portions so as to form predetermined gaps between the facing surfaces and the coil bodies. The movable body is arranged to be movable relative to the holder in response to receipt of the operation force.

In the input device according to the first aspect, it is possible to reduce size of each of the magnetic pole formation portions and also ensure a sufficient strength for a generable electromagnetic force.

In a second aspect of the present disclosure, an input device to which an operation force in a direction along a virtual operation plane is inputted comprises four coil bodies, a holder, four magnetic pole formation portions and a movable body. Each coil body includes a winding wire to which a current is applied. Each winding wire is wound to form four sides extending in an x-axis direction and a y-axis direction each along the operation plane. The holder holds the coil bodies such that the coil bodies are arranged two by two in the x-axis and y-axis directions and are arranged in a crisscross with a center region. Four sides of the center region are surrounded by the four coil bodies. Each magnetic pole formation portion has a facing surface that faces two of the four coil bodies in a winding axis direction of the winding wire. The magnetic pole formation portions are arranged two by two in the x-axis and y-axis directions such that the facing surfaces have alternate polarities. Electromagnetic forces are generated between the coil bodies and the magnetic pole formation portions when current applied to the winding wires. The movable body holds the four magnetic pole formation portions such that predetermined gaps are formed between the facing surfaces and the coil bodies. The movable body is arranged to be movable relative to the holder in response to receipt of the operation force.

The four magnetic pole formation portions constitute a magnetic pole body. A maximum length of the magnetic pole body along the y-axis is defined as a y-axis direction length of the magnetic pole body. A maximum length of the magnetic pole body along the y-axis is defined as a y-axis direction length of the magnetic pole body. The coil bodies include a pair of coil bodies arranged in the x-axis direction. A specific side of the four sides of each coil body in the pair of coil bodies arranged in the x-axis direction is a side that extends in the y-axis direction and that is most distant from the center region among the four sides. A maximum distance between the specific side of one coil body in the pair of coil bodies arranged in the x-axis direction and the specific side of the other coil body in the pair of coil bodies arranged in the x-axis direction is defined as a distance between outer edges in the x-axis direction. The coil bodies include a pair of coil bodies arranged in the y-axis direction. A specific side of the four sides of each coil body in the pair of coil bodies arranged in the y-axis direction is a side that extends in the x-axis direction and that is most distant from the center region among the four sides. A maximum distance between the specific side of one coil body in the pair of coil bodies arranged in the y-axis direction and the specific side of the other coil body in the pair of coil bodies arranged in the y-axis direction is defined as a distance between outer edges in the y-axis direction. The x-axis direction length of the magnetic pole body is shorter than the distance between the outer edges in the x-axis direction. The y-axis direction length of the magnetic pole body is shorter than the distance between the outer edges in the y-axis direction.

In the input device according to the second aspect, it is possible to reduce the size of each of the magnetic pole formation portions and also ensure a sufficient strength for a generable electromagnetic force.

### BRIEF DESCRIPTION OF DRAWINGS

The above and other objects, features and advantages of the present disclosure will become more apparent from the following detailed description made with reference to the accompanying drawings. In the drawings:

FIG. 1 is a diagram for illustrating a configuration of a display system including an input device according to a first embodiment of the present disclosure;

FIG. 2 is a diagram for illustrating an arrangment of the input device in a vehicle compartment;

FIG. 3 is a diagram for illustrating a mechanical configuration of the input device;

FIG. 4 is a diagram schematically showing a configuration of a reaction force generator, which is a cross-sectional view along the line IV-IV in FIG. 3;

FIG. 5 is a schematic diagram showing a principle of how electromagnetic forces in an x-axis direction are generated in the reaction force generator;

FIG. 6 is a schematic diagram showing a principle of how electromagnetic forces in a y-axis direction are generated in the reaction force generator;

FIG. 7 is a schematic diagram showing a principle of how the strength of a generable electromagnetic force is maintained even in a state where a magnet combination is moved in a leftward direction;

FIG. 8 is a schematic diagram showing a principle of how the strength of the generable electromagnetic force is maintained even in a state where the magnet combination is moved in a forward direction; and

FIG. 9 is a schematic diagram showing a principle of how the strength of the generable electromagnetic force is maintained even in a state where the magnet combination is moved in a right rearward direction.

### EMBODIMENTS FOR CARRYING OUT INVENTION

A first embodiment of the present disclosure will be described below on the basis of the drawings.

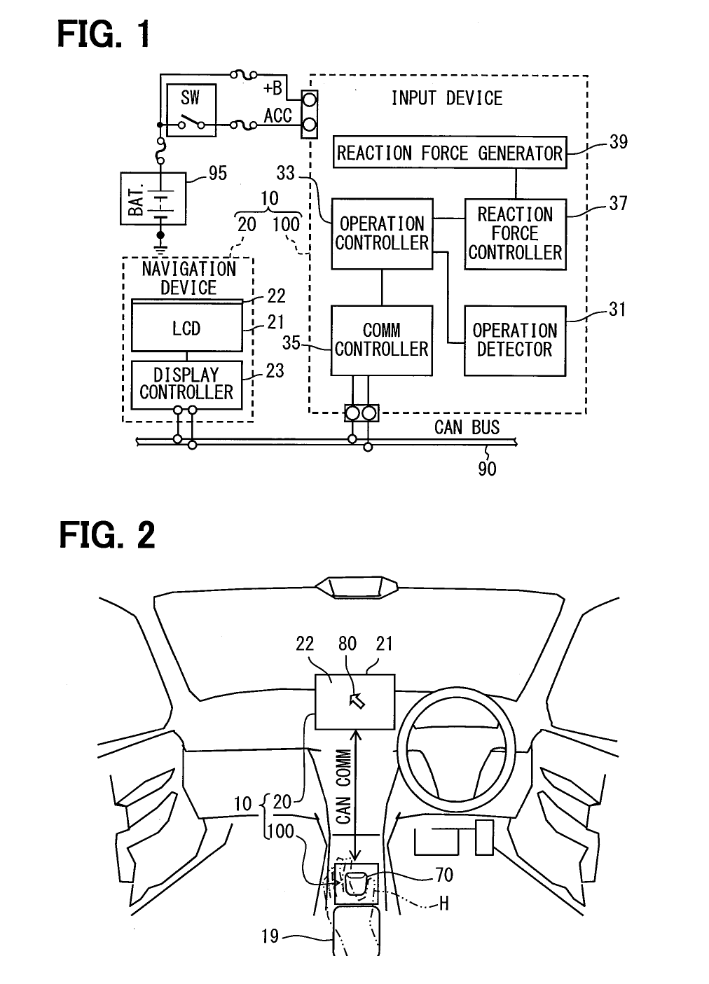

An input device 100 according to the first embodiment of the present disclosure is mounted in a vehicle to constitute a display system 10 in conjunction with a navigation device 20 and the like, as shown in FIG. 1. As shown in FIG. 2, the input device 100 is placed at a position adjacent to a palm rest 19 at the center console of the vehicle and exposes an operation knob 70 within easy reach of an operator. When an operation force is input to the operation knob 70 with a hand H of the operator or the like, the operation knob 70 is displaced in the direction of the input operation force. The navigation device 20 is placed in the instrument panel of the vehicle and exposes a display screen 22 toward a driver seat. The display screen 22 displays a plurality of icons associated with predetermined functions, a pointer 80 for selecting any of the icons, and the like. When the operation force in a horizontal direction is input to the operation knob 70, the pointer 80 moves over the display screen 22 in a direction corresponding to the direction in which the operation force is input.

The respective configurations of the above input device 100 and navigation device 20 will be described in detail.

As shown in FIG. 1, the input device 100 is connected to a controller area network (CAN) bus 90, an external battery 95, and the like. The CAN bus 90 is a transmission path used to transmit data between a plurality of vehicle-mounted devices, which are mounted in the vehicle in an in-vehicle communication network, in which the vehicle-mounted devices are connected to each other. The input device 100 can perform CAN communication with the separately-placed navigation device 20 through the CAN bus 90. The input device 100 is supplied with the electric power required to activate each of the components from the battery 95.

The input device 100 electrically includes a communication controller 35, an operation detector 31, a reaction force generator 39, a reaction force controller 37, an operation controller 33, and the like.

The communication controller 35 outputs the information processed by the operation controller 33 to the CAN bus 90. In addition, the communication controller 35 acquires the information outputted from another vehicle-mounted device to the CAN bus 90 and outputs the information to the operation controller 33. The operation detector 31 detects the position of the operation knob 70 (see FIG. 2) that has moved on receiving the operation force. The operation detector 31 outputs operation information showing the detected position of the operation knob 70 to the operation controller 33.

The reaction force generator 39 is configured to generate an operation reaction force in the operation knob 70 and includes an actuator such as a voice coil motor. For example, when the pointer 80 (see FIG. 2) overlaps any of the icons on the display screen 22, the reaction force generator 39 applies the operation reaction force to the operation knob 70 (see FIG. 2) to cause the operator to have a fake feeling of touching the icon. The reaction force controller 37 includes a microcomputer for performing, e.g., a variety of processing and the like. The reaction force controller 37 controls the direction and strength of the operation reaction force applied from the reaction force generator 39 to the operation knob 70 on the basis of reaction force information acquired from the operation controller 33.

The operation controller 33 includes the microcomputer for performing, e.g., a variety of processing and the like. The operation controller 33 acquires the operation information detected by the operation detector 31 and outputs the operation information to the CAN bus 90 through the communication controller 35. In addition, the operation controller 33 performs processing to determine the direction and strength of the operation reaction force to be applied to the operation knob 70 (see FIG. 2) and outputs the results of the processing as reaction force information to the reaction force controller 37.

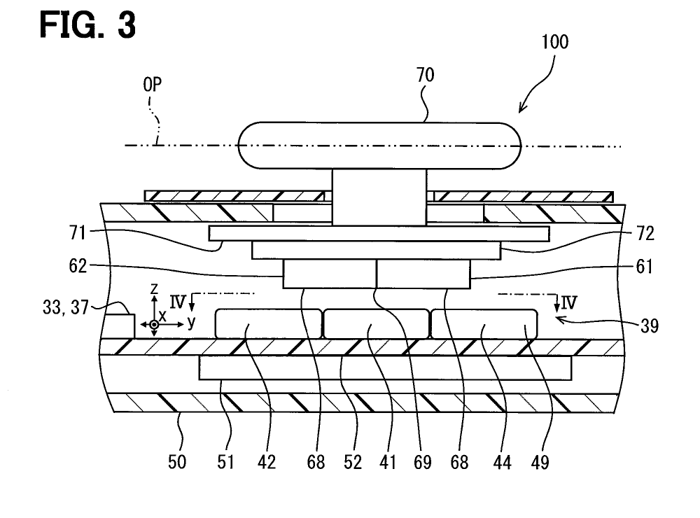

As shown in FIG. 3, the input device 100 mechanically includes the operation knob 70 described above, a housing 50, and the like.

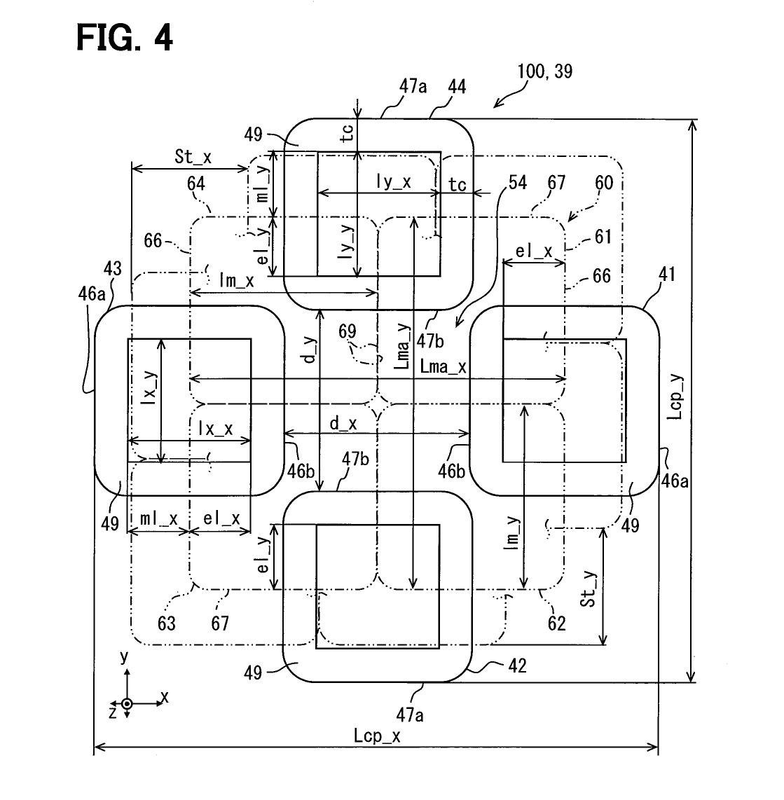

The operation knob 70 is arranged movable relative to the housing 50 in an x-axis direction and a y-axis direction along a virtual operation plane OP. The operation knob 70 has respective ranges in which the operation knob 70 is movable in the x-axis and y-axis directions. The ranges are pre-defined by the housing 50. When released from the applied operation force, the operation knob 70 returns to a reference position serving as a reference. It is assumed here that the distance over which the operation knob 70 is bilaterally movable along the x-axis is a full stroke amount St_x (see FIG. 4) in the x-axis direction and the distance over which the operation knob 70 is bilaterally movable along the y-axis is a full stroke amount St_y (see FIG. 4) in the y-axis direction. In the present embodiment, each of the full stroke amounts St_x and St_y in the individual axis directions is set to, e.g., about 15 millimeters (mm). The full stroke amounts St_x and St_y in the individual axis directions are to be changed as required.

The housing 50 is a case which contains the components including a circuit board 52, the reaction force generator 39, and the like, while supporting the operation knob 70 relatively movably. The circuit board 52 is fixed in the housing 50 with the plate surface direction of the circuit board 52 being along the operation plane OP. On the circuit board 52, the microcomputer constituting the operation controller 33, the reaction force controller 37, and the like and so forth are mounted.

As shown in FIGS. 1 and 2, the navigation device 20 is connected to the CAN bus 90 and can perform CAN communication with the input device 100 or the like. The navigation device 20 includes a display controller 23 which draws an image to be displayed on the display screen 22 and a liquid crystal display 21 which continuously displays the image drawn by the display controller 23 on the display screen 22.

Next, a configuration of the reaction force generator 39 used for a reaction force feedback in the input device 100 will be further described on the basis of FIGS. 2 to 4. The reaction force generator 39 includes four coils 41 to 44, a stationary yoke 51, a movable yoke 72, four magnets 61 to 64, and the like.

Each of the coils 41 to 44 is formed by winding a wire made of a non-magnetic material such as copper into a winding wire 49. Each of the winding wires 49 is wound until the winding wire 49 has a thickness tc (e.g., about 3 mm) and is electrically connected to the reaction force controller 37. A current is applied individually to the winding wires 49 by the reaction force controller 37.

Each of the coils 41 to 44 is mounted on the circuit board 52 with the winding axis direction of the winding wire 49 being along a z-axis orthogonal to the operation plane OP. Each of the coils 41 to 44 is formed to have a substantially square traverse section. Each of the coils 41 to 44 is held on the circuit board 52 with the winding wire 49 extending along each of the x-axis and y-axis directions.

The foregoing four coils 41 to 44 are arranged in a crisscross. Specifically, the pair of coils 41 and 43 are arranged spaced apart from each other in the x-axis direction, while the pair of coils 42 and 44 are arranged spaced apart from each other in the y-axis direction. Due to such a “crisscross” arrangement, a center region 54 surrounded by the four coils 41 to 44 on four sides is formed.

Each of the stationary yoke 51 and the movable yoke 72 is made of a magnetic material and formed into a rectangular plate shape. The stationary yoke 51 is attached to the surface of the circuit board 52 which is opposite to the mounting surface of the circuit board 52 on which the coils 41 to 44 are mounted. The stationary yoke 51 inhibits the magnetic flux generated from each of the coils 41 to 44 from leaking to the outside. The movable yoke 72 is attached to a knob base 71 provided on the operation knob 70. The knob base 71 is formed in a plate shape along the circuit board 52 and contained in the housing 50. The movable yoke 72 inhibits the magnetic flux generated from each of the magnets 61 to 64 from leaking to the outside.

Each of the magnets 61 to 64 is a neodymium magnet or the like and formed in a plate shape. Each of the magnets 61 o 64 has a quadrilateral shape having sides 69 of equal lengths. In the present embodiment, each of the magnets 61 to 64 is formed in a substantially square shape. Each of the magnets 61 to 64 is held on the movable yoke 72 with the direction of each of the sides 69 being along the x-axis or the y-axis.

The four magnets 61 to 64 are arranged two by two in the x-axis and y-axis directions. Each of the four magnets 61 to 64 has a facing surface 68 which faces the circuit board 52 in a state where the magnet is held on the movable yoke 72. Each of the facing surfaces 68 of the four magnets 61 to 64 is a flat and smooth surface having a substantially square shape. Each of the facing surfaces 68 faces the end surfaces of two of the four coils 41 to 44 in the z-axis direction. The facing surfaces 68 have polarities, i.e., two magnetic poles called an N-pole and an S-pole which alternate in each of the x-axis and y-axis directions.

Description will be given of a principle of how the above-configured reaction force generator 39 generates the operation reaction force, which is to be applied to the operation knob 70. The reaction force generator 39 can individually control an operation reaction force acting in the x-axis direction and an operation reaction force acting in the y-axis direction.

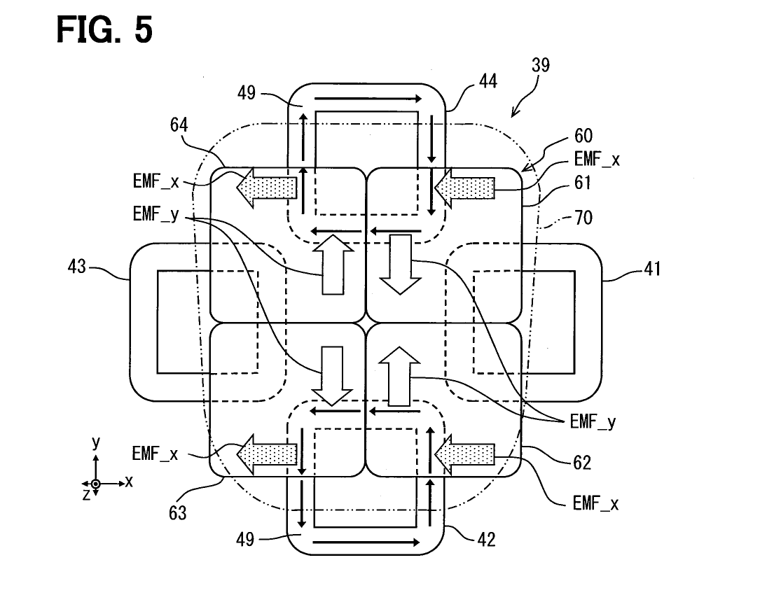

First, description will be given of a case where the operation reaction force in the x-axis direction is generated in a state where an integrated combination 60 of the four magnets 61 to 64 (hereinafter referred to as a magnet combination) has returned together with the operation knob 70 to the reference position as shown in FIG. 5. In this case, the reaction force controller 37 applies a current to each of the coils 42 and 44 arranged in the y-axis direction (see FIG. 1). In a top view viewed from the movable yoke 72 (see FIG. 3) toward the stationary yoke 51 (see FIG. 3), a clockwise current flows in the coil 44, and a counter clockwise current opposite to the direction of the current flowing in the coil 44 flows in the coil 42.

Due to the foregoing currents, an electromagnetic force EMF_y in a direction from the coil 44 toward the coil 42 along the y-axis (hereinafter referred to as a “rearward direction”) is generated in the portion of the winding wire 49 of the coil 44 which extends in the x-axis direction and overlaps the magnet 61 in the z-axis direction. Also, the electromagnetic force EMF_y in a direction from the coil 42 to the coil 44 along the y-axis (hereinafter referred to as a “forward direction”) is generated in the portion of the winding wire 49 of the coil 44 which extends in the x-axis direction and overlaps the magnet 64 in the z-axis direction. Likewise, the respective electromagnetic forces EMF_y in the forward and rearward directions are generated in the portions of the winding wire 49 of the coil 44 which extend in the x-axis direction and overlap the magnets 62 and 63 in the z-axis direction. These electromagnetic forces EMF_y in the y-axis direction cancel out each other.

Electromagnetic forces EMF_x in a direction from the coil 41 toward the coil 43 along the x-axis (hereinafter referred to as a “leftward direction”) are generated in the portions of the winding wire 49 of the coil 44 which extend in the y-axis direction and overlap the magnets 61 and 64 in the z-axis direction. Likewise, the electromagnetic forces EMF_x in the leftward direction are generated in the portions of the winding wire 49 of the coil 42 which extend in the y-axis direction and overlap the magnets 62 and 63 in the z-axis direction. The reaction force generator 39 allows these electromagnetic forces EMF_x to act as the operation reaction force in the x-direction on the operation knob 70.

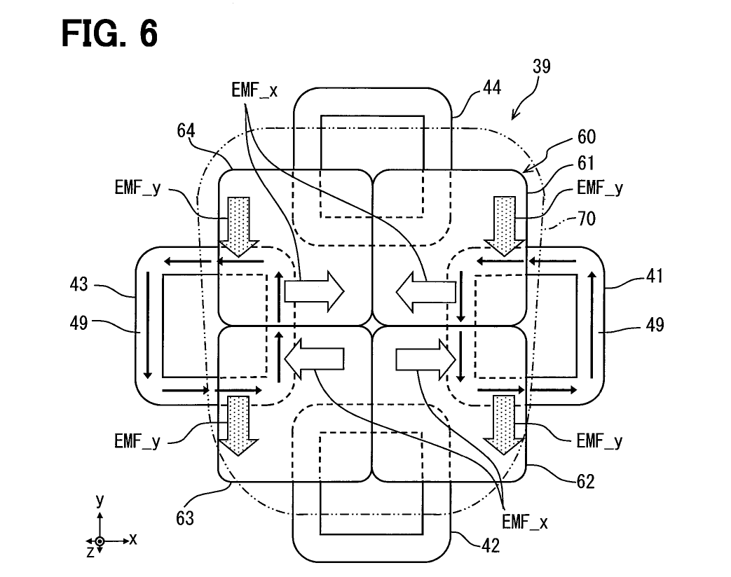

Next, description will be given of a case where the operation reaction force in the y-axis direction is generated in a state where the magnet combination 60 has returned together with the operation knob 70 to the reference position as shown in FIG. 6. In this case, currents are applied from the reaction force controller 37 to the coils 41 and 43 arranged in the x-axis direction (see FIG. 1). In the top view, a counterclockwise current flows in the coil 41, and a clockwise current opposite to the direction of the current flowing in the coil 41 flows in the coil 43.

Due to the foregoing currents, the electromagnetic force EMF_x in the leftward direction is generated in the portion of the winding wire 49 of the coil 41 which extends in the y-axis direction and overlaps the magnet 61 in the z-axis direction. Also, the electromagnetic force EMF_y in a direction from the coil 43 toward the coil 41 along the x-axis (hereinafter referred to as a “rightward direction”) is generated in the portion of the winding wire 49 of the coil 41 which extends in the x-axis direction and overlaps the magnet 62 in the z-axis direction. Likewise, the respective electromagnetic forces EMF_x in the leftward and rightward directions are generated in the portions of the winding wire 49 of the coil 43 which extend in the y-axis direction and overlap the magnets 63 and 64 in the z-axis direction. These electromagnetic forces EMF_x in the x-axis direction cancel out each other.

The electromagnetic forces EMF_y in the rearward direction are generated in the portions of the winding wire 49 of the coil 41 which extend in the x-axis direction and overlap the magnets 61 and 62 in the z-axis direction. Likewise, the electromagnetic forces EMF_x in the rearward direction are generated in the portions of the winding wire 49 of the coil 43 which extend in the x-axis direction and overlap the magnets 63 and 64 in the z-axis direction. The reaction force generator 39 allows these electromagnetic forces EMF_y to act as the operation reaction force in the y-direction on the operation knob 70.

The foregoing reaction force generator 39 controls the magnitudes of the respective currents applied from the reaction force controller 37 (see FIG. 1) to the individual coils 41 to 44 and thus adjusts the magnitudes of the operation reaction forces in the individual axis directions. In addition, the directions of the respective currents applied to the individual coils 41 to 44 are changed to switch the directions of the operation reaction forces acting on the magnet combination 60.

In the above-described reaction force generator 39, to generate a predetermined operation reaction force, each of the winding wires 49 of the individual coils 41 to 44 shown in FIG. 3 needs to overlap the magnet combination 60 over a predefined length or longer in the z-axis direction. Specifically, to generate the predetermined electromagnetic force EMF_x (see FIG. 5) in the x-axis direction, the portion of each of the winding wires 49 of the individual coils 42 and 44 which extends in the y-axis direction needs to overlap the magnet combination 60 over the pre-defined length or longer. Accordingly, a length el_y (hereinafter referred to as an “effective length in the y-axis direction”) is defined as the range in which the portion of the winding wire 49 extending in the y-axis direction overlaps the magnet combination 60. The length el_y in a state where the magnet combination 60 is at the reference position is predefined.

Likewise, to generate the predetermined electromagnetic force EMF_y (see FIG. 6) in the y-axis direction, the portion of each of the winding wires 49 of the individual coils 41 and 43 which extends in the x-axis direction needs to overlap the magnet combination 60 over a predefined length or longer in the z-axis direction. Accordingly, a length el_x (hereinafter referred to as an “effective length in the x-axis direction”) is defined as the range in which the portion of the winding wire 49 extending in the x-axis direction overlaps the magnet combination 60. The length el_x in the state where the magnet combination 60 is at the reference position is predefined.

The foregoing effective lengths el_x and el_y in the individual axis directions can be maintained even when the movement of the operation knob 70 moves the magnet combination 60 from the reference position (see FIG. 3). The following will describe a configuration of the reaction force generator 39 for maintaining these effective lengths el_x and el_y.

In the magnet combination 60, the respective adjacent sides 69 of the juxtaposed facing surfaces 68 (see FIG. 3) are in contact with each other with no gap formed therebetween. In the magnet combination 60, the maximum length of the magnet combination 60 in the x-axis direction, i.e., the distance from one of the two outer edges 66 extending in the y-axis direction to the other is assumed to be Lma_x. Likewise, in the magnet combination 60, the maximum length of the magnet combination 60 in the y-axis direction, i.e., the distance from one of the two outer edges 67 extending in the x-axis direction to the other is assumed to be Lma_y.

In the pair of coils 41 and 43 arranged in the x-axis direction, it is assumed that, among the four sides of each coil 41 and 43, the one side extending in the y-axis direction and located further away from the center region 54 is an outer edge 46a. It is also assumed that the maximum distance from one of the two outer edges 46a to the other along the x-axis is a distance Lcp_x between the outer edges of the pair of coils 41 and 43 in the x-axis direction. Likewise, in the pair of coil bodies 42 and 44 arranged in the y-axis direction, it is assumed that, among the four sides of each coil body 42 and 44, the one side extending in the x-axis direction and located further away from the center region 54 is an outer edge 47a. It is also assumed that the maximum distance from one of the two outer edges 47a to the other along the y-axis is a distance Lcp_y between the outer edges of the pair of coils 42 and 44 in the y-axis direction.

The length Lma_x of the magnet combination 60 in the x-axis direction is set shorter than the distance Lcp_x between the outer edges in the x-axis direction determined by the pair of coils 41 and 43. In addition, the length Lma_y of the magnet combination 60 in the y-axis direction is set shorter than the distance Lcp_y between the outer edges in the y-axis direction determined by the pair of coils 42 and 44. The foregoing configuration allows the magnet combination 60 to move within the range surrounded by the respective outer edges 46a and 47a of the four coils 41 to 44, while being held on the operation knob 70 (see FIG. 3).

Each of the magnets 61 to 64 is formed in a quadrilateral shape proximate to that of each of the coils 41 to 44. Specifically, a length lm_x of each magnet 61 to 64 in the x-axis direction is set to the total sum of half of the length of the full stroke amount St_x in the x-axis direction, double of the thickness tc of the winding wire 49, and the effective length el_x in the x-axis direction. In addition, a length lm_y of each of the magnets 61 to 64 in the y-axis direction is set to the total sum of half of the length of the full stroke amount St_y in the y-axis direction, double of the thickness tc of the winding wire 49, and the effective length el_y in the y-axis direction.

The foregoing magnet combination 60 is movable in the rightward and leftward directions from the reference position over the distance corresponding to half the full stroke amount St_x in the x-axis direction. The magnet combination 60 is also movable in the forward and rearward directions from the reference position over the distance corresponding to half the full stroke amount St_y in the y-axis direction.

It is ensured that, in a state where the magnet combination 60 is at the reference position, a length ml_x of the portion of the winding wire 49 of the coil 43 which extends in the x-axis direction and also protrudes from the magnets 63 and 64 (hereinafter referred to as an “allowance length in the x-axis direction”) is greater than or equal to a stroke amount St_x/2 in the leftward direction. It is ensured that, in the state where the magnet combination 60 is at the reference position, the length of the portion of the winding wire 49 of the coil 43 which extends in the x-axis direction and also overlaps the magnets 63 and 64 is greater than or equal to the stroke amount St_x/2 in the rightward direction to serve as the effective length el_x in the x-axis direction. For the portions of the winding wire 49 of the coil 41 which extend in the x-axis direction also, the same settings are made.

It is also ensured that, in the state where the magnet combination 60 is at the reference position, a length ml_y of the portion of the winding wire 49 of the coil 44 which extends in the y-axis direction and also protrudes from the magnets 64 and 61 (hereinafter referred to as an “allowance length in the y-axis direction”) is greater than or equal to a stroke amount St_y/2 in the forward direction. It is ensured that, in the state where the magnet combination 60 is at the reference position, the length of the portion of the winding wire 49 of the coil 44 which extends in the y-axis direction and also overlaps the magnets 64 and 61 is greater than or equal to the stroke amount St_y/2 in the rearward direction to serve as the effective length el_y in the y-axis direction. For the portions of the winding wire 49 of the coil 42 which extend in the y-axis direction also, the same settings are made.

In addition, it is ensured that in the coils 41 and 43 arranged in the x-axis direction, a length lx_y of the portion of each winding wire 49 which extends in the y-axis direction is greater than or equal to the full stroke amount St_y in the y-axis direction. It is also ensured that in the coils 42 and 44 arranged in the y-axis direction, a length ly_x of the portion of each winding wire 49 which extends in the x-axis direction is greater than or equal to the full stroke amount St_x in the x-axis direction.

A x-axis direction length d_x of the center region 54 surrounded by the foregoing individual coils 41 to 44 is an internal dimension from an inner edge 46b of one of the coils 41 and 43 arranged in the x-axis direction to the inner edge 46b of the other of the coils 41 and 43. It is ensured that the length d_x of the center region 54 is greater than or equal to the full stroke amount St_x in the x-axis direction. In the present embodiment, the length d_x is obtained by adding up the above-described full stroke amount St_x and double of the thickness tc of the winding wire 49. The length d_x is substantially the same as the length of each of the coils 42 and 44 in the x-axis direction.

A length d_y in the y-axis direction of the center region 54 is an internal dimension from an inner edge 47b of one of the coils 42 and 44 arranged in the y-axis direction to the inner edge 47b of the other of the coils 42 and 44. It is ensured that the length d_y of the center region 54 is greater than or equal to the full stroke amount St_y in the y-axis direction. In the present embodiment, the length d_y is obtained by adding up the above-described full stroke amount St_y and double of the thickness tc of the winding wire 49. The length d_y is substantially the same as the length of each of the coils 41 and 43 in the y-axis direction.

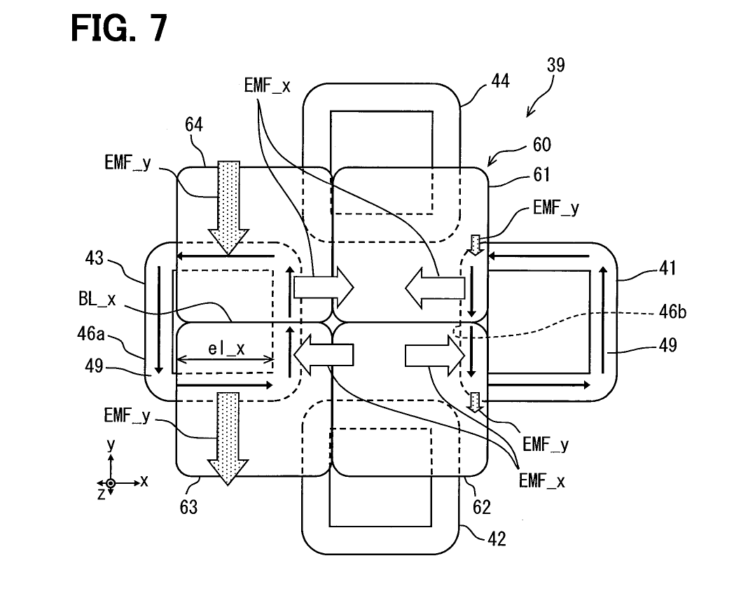

Description will be given of a case where the magnet combination 60 of the foregoing reaction force generator 39 is moved in the leftward direction as shown in FIG. 7. In this case, the range in which the respective facing surfaces 68 (see FIG. 3) of the magnets 61 and 62 are overlapping the coil 41 decreases, where the magnets 61 and 62 are located on the rear side (right side) in the movement direction and the coil 41 is located on the rear side in the movement direction. Accordingly, the effective length el_x of the coil 41 in the x-axis direction decreases. However, the range in which the respective facing surfaces 68 of the magnets 63 and 64 are overlapping the coil 43 increases, where the magnets 63 and 64 are located on the front side (left side) in the movement direction and the coil 43 is located on the front side in the movement direction. Accordingly, the effective length el_x of the coil 43 in the x-axis direction increases. Thus, the total sum of the respective effective lengths el_x of the coils 41 and 43 in the x-axis direction is maintained even when the magnet combination 60 is moved in the x-axis direction. Therefore, the generable electromagnetic force EMF_y in the y-axis direction can be maintained.

In addition, since a boundary BL_x between the magnet 64, 61 and the magnet 62, 63 is along the x-axis, even when the magnet combination 60 is moved in the left-right direction, an electromagnetic force EMF_x generated in the portion of the winding wire 49 of each coil 41, 43 which extends in the y-axis direction is inhibited from fluctuating. Therefore, the mutual cancel out of these electromagnetic forces EMF_x can be maintained.

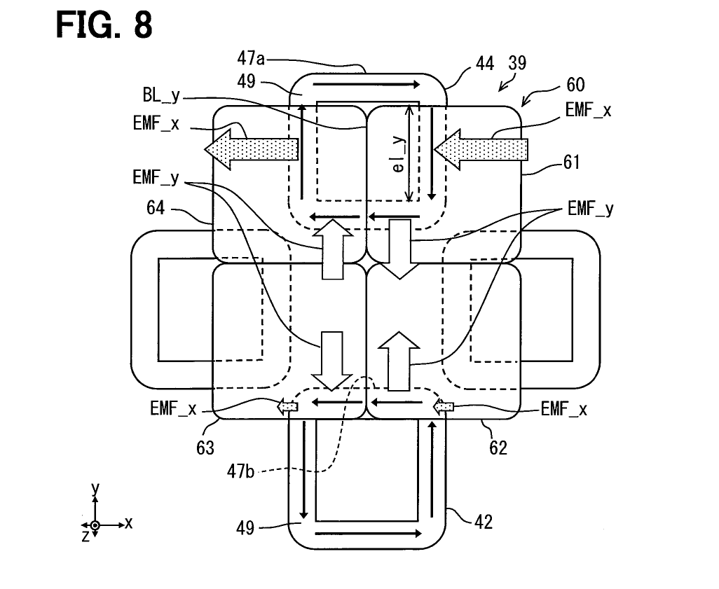

Next, description will be given of a case where the magnet combination 60 is moved in the forward direction as shown in FIG. 8. In this case, the range in which the respective facing surfaces 68 (see FIG. 3) of the magnets 62 and 63 are overlapping the coil 42 decreases, where the magnets 62 and 63 are located on the rear side (rearward) in the movement direction and the coil 42 is located on the rear side (rearward) in the movement direction. Accordingly, the effective length el_y of the coil 42 in the y-axis direction decreases. However, the range in which the respective facing surfaces 68 of the magnets 64 and 61 are overlapping the coil 44 increases, where the magnets 64 and 61 are located on the front side (forward) in the movement direction and the coil 44 is located on the front side in the direction movement. Accordingly, the effective length el_y of the coil 44 in the y-axis direction increases. Thus, the total sum of the respective effective lengths el_y of the coils 42 and 44 in the y-axis direction is maintained even when the magnet combination 60 is moved in the y-axis direction. Therefore, the generable electromagnetic force EMF_x in the x-axis direction can be maintained.

In addition, since a boundary BL_y between the magnet 61, 62 and the magnet 63, 64 is along the y-axis, even when the magnet combination 60 is moved in the front-rear direction, the electromagnetic force EMF_y generated in the portion of the winding wire 49 of each coil 42, 44 which extends in the x-axis direction is inhibited from fluctuating. Therefore, the mutual cancel out of these electromagnetic forces EMF_y can be maintained.

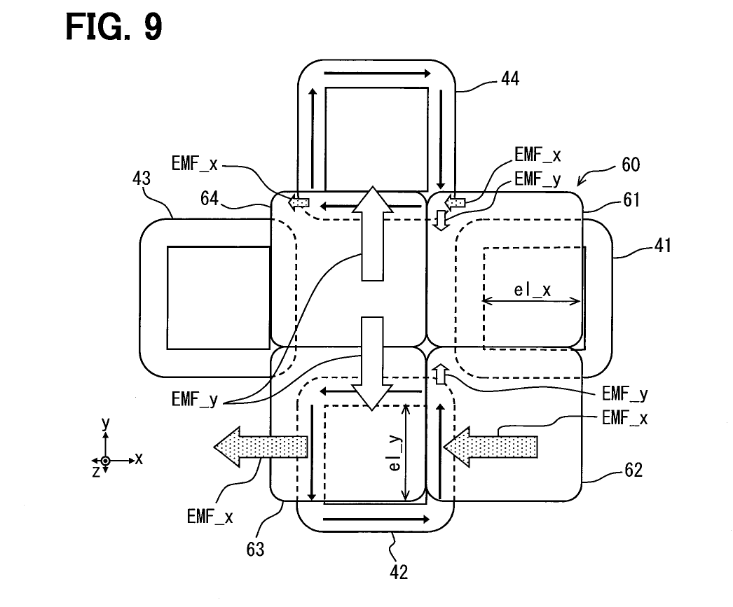

Next, description will be given of a case where the magnet combination 60 is moved in the rearward and rightward directions as shown in FIG. 9. In this case also, both of the total sum of the respective effective lengths el_x of the coils 41 and 43 in the x-axis direction and the total sum of the respective effective lengths el_y of the coils 42 and 44 in the y-axis direction are maintained. Therefore, the generable electromagnetic forces EMF_x and EMF_x in the individual axis directions can be maintained.

In addition, when, e.g., a current is applied to each of the coils 42 and 44, the electromagnetic force EMF_y generated between the coil 42 and the magnet 63 and the electromagnetic force EMF_y generated between the coil 44 and the magnet 64 cancel out each other. Likewise, the electromagnetic force EMF_y generated between the coil 42 and the magnet 62 and the electromagnetic force EMF_y generated between the coil 44 and the magnet 61 cancel out each other. Thus, even when the magnet combination 60 is moved right rearwardly, the balance between the electromagnetic forces EMF_y in the y-axis direction can be maintained.

In the present embodiment described heretofore, the magnet combination 60 fixed to the operation knob 70 moves relative to each of the coils 41 to 44 fixed to the housing 50. In such a combination, the full stroke amount St_x of the magnet combination 60 required in the x-axis direction can be ensured by the pair of magnets 61 and 64 or magnets 62 and 63 arranged in the x-axis direction. Accordingly, the length Im_x required for each one of the magnets 61 to 64 in the x-axis direction can be reduced. For the same reason, the length Im_y required for each one of the magnets 61 to 64 in the y-axis direction can be reduced.

As described above, even when the magnet combination 60 is moved in the x-axis and y-axis directions, the respective effective lengths el_x and el_y in the individual axis directions can be maintained, and consequently the generable electromagnetic forces EMF_x and EMF_y in the individual axis directions can be maintained. This reduces the size of each of the magnets 61 and 64 and also implements the input device 100 for which the generable electromagnetic forces EMF_x and EMF_y are ensured.

In the present embodiment, each of the coils 41 to 44 is mounted on the circuit board 52. Accordingly, other circuit board than the circuit board 52, wires for connecting the individual boards to each other, and the like may be unneeded in the operation knob 70. This simplifies the structure capable of moving, and accordingly, the operation knob 70 can be smoothly displaced in response to input of an operation force.

According to the present embodiment, the respective sides 69 of the facing surfaces 68 each having a rectangular shape are along the x-axis or the y-axis. Consequently, even when the magnet combination 60 is moved in the left-right direction (see FIG. 7), it is possible to inhibit fluctuations in the effective length el_y of each of the coils 42 and 44 in the y-axis direction. This can also inhibit fluctuations in the generable electromagnetic force EMF_x in the x-axis direction. Likewise, even when the magnet combination 60 is moved in the front-rear direction (see FIG. 8), it is possible to inhibit fluctuations in the effective length el_x of each of the coils 41 and 43 in the x-axis direction. This can also inhibit fluctuations in the generable electromagnetic force EMF_y in the y-axis direction.

In the present embodiment, the length Im_x of each of the magnets 61 to 64 in the x-axis direction is set to the above-described value. Consequently, even when, e.g., the magnet combination 60 is maximally moved (see FIG. 7) in the leftward direction, each of the magnets 63 and 64 is prevented from getting to the winding wire portion of the coil 43 which forms the outer edge 46a. In addition, each of the magnets 61 and 62 is also prevented from getting away from the winding wire portion of the coil 41 which forms the inner edge 46b. Such “getting to/away from” motions of the magnet combination 60 can also be similarly prevented even when the magnet combination 60 is maximally moved in the rightward direction (see FIG. 9).

The length lm_y of each of the magnets 61 to 64 in the y-axis direction is set to the above-described value. Consequently, even when, e.g., the magnet combination 60 is maximally moved in the forward direction (see FIG. 8), each of the magnets 64 and 61 is prevented from getting to the winding wire portion of the coil 44 which forms the outer edge 47a. In addition, each of the magnets 62 and 63 is also prevented from getting away from the winding wire portion of the coil 42 which forms the inner edge 47b. Such “getting to/away from” motions of the magnet combination 60 can also be similarly prevented even when the magnet combination 60 is maximally moved in the rearward direction (see FIG. 9).

As a result, the total sums of the effective lengths el_x and el_y in the individual axis directions and accordingly the strengths of the electromagnetic forces EMF_x and EMF_y generable in the individual axis directions can surely be maintained until the magnet combination 60 is maximally moved.

Additionally, in the present embodiment, the individual magnets 61 to 64 are arranged such that the respective sides 69 adjoin each other (see FIG. 4). This can achieve a reduction in the size of the magnet combination 60. In addition, the size reduction of the magnet combination 60 allows reductions in the distances Lcp_x and Lcp_y between the outer edges 46a and between the outer edges 47a in the respective coils 41 to 44. As a result, it becomes possible to reduce not only the size of each of the magnets 61 to 64, but also the size of the input device 100.

Additionally, in the present embodiment, it is ensured that e.g., the allowance length ml_x of the portion of the coil 41 which protrudes from the magnets 61 and 62 in the x-axis direction is greater than or equal to the stroke amount ST_x/2 in the rightward direction (see FIG. 4). Likewise, it is also ensured that each of the portions of the other coils 42 to 44 which protrude from the magnets 61 to 64 has a sufficient length. Accordingly, even when the magnet combination 60 is maximally moved in any direction, a situation where the magnet combination 60 gets to the winding wire portions which form the outer edges 46a and 47a can be avoided. This can continuously cause increases in the effective lengths el_x and el_y resulting from the movement of the magnet combination 60. Consequently, the strengths of the generable electromagnetic forces EMF_x and EMF_y can continuously be maintained until the magnet combination 60 is maximally moved.

According to the present embodiment, it is ensured that, e.g., the length el_x of the portion of the coil 41 which overlaps the magnets 61 and 62 is greater than or equal to the stroke amount St_x/2 in the leftward direction (see FIG. 4). Likewise, it is also ensured that each of the portions of the other coils 42 to 44 which overlap the magnets 61 to 64 has a sufficient length. Accordingly, even when the magnet combination 60 is maximally moved in any direction, it is possible to avoid a situation where the magnet combination 60 gets away from the winding wire portions forming the inner edges 46b and 47b. As a result, it is possible to reliably maintain a state where the electromagnetic forces EMF_x and EMF_y in the directions in which the electromagnetic forces EMF_x and EMF_y should not be applied to the operation knob 70 have cancelled out each other.

Additionally, in the present embodiment, it is ensured that the length d_x of the center region 54 in the x-axis direction is greater than or equal to the full stroke amount St_x in the x-axis direction. Consequently, even when, e.g., the magnet combination 60 is maximally moved in the leftward direction (see FIG. 7), the magnets 61 and 62 do not overlap the coil 43. Likewise, even when the magnet combination 60 is maximally moved in the rightward direction (see FIG. 9), the magnets 63 and 64 do not overlap the coil 41.

In addition, it is also ensured that the length d_y of the center region 54 in the y-axis direction is greater than or equal to the full stroke amount St_y in the y-axis direction. Consequently, even when the magnet combination 60 is maximally moved in the forward direction (see FIG. 8), the magnets 62 and 63 do not overlap the coil 44. Likewise, even when the magnet combination 60 is maximally moved in the rearward direction (see FIG. 9), the magnets 64 and 61 do not overlap the coil 42.

In the foregoing configuration, it is possible to reliably maintain the state where the electromagnetic forces EMF_x and EFM_y in the directions in which the electromagnetic forces EMF_x and EFM_y should not be applied have cancelled out each other.

Note that, in the present embodiment, the coil 41 to 44 corresponds to “coil body” in claims, and the circuit board 52 corresponds to “holder” in claims. Also, the magnet combination 60 corresponds to “magnetic pole body” in claims, the magnet 61 to 64 corresponds to the “magnetic pole formation portion” in claims, and the movable yoke 72 corresponds to the “movable body” in claims.

### Other Embodiments

While the description has thus been given of the first embodiment of the present disclosure, the present disclosure is not intended to be construed as being limited to the foregoing embodiment. The present disclosure is applicable to various embodiments and a combination thereof without departing from the scope of the disclosure.

In the foregoing embodiment, by combining the four magnets 61 to 64 corresponding to the “magnetic pole formation portions”, the magnet combination 60 corresponding to the “magnetic pole body” is formed. However, a configuration corresponding to the “magnetic pole formation portions” and the “magnetic pole body”, which generate a magnetic field in which polarities alternate in individual axis directions, may be modified as required. For example, one magnet magnetized to have magnetic poles such as an N-pole and an S-pole which alternate in the individual axis directions may also have four “magnetic pole formation portions” as a configuration corresponding to the “magnetic pole body”. Alternatively, the “magnetic pole body” may also be configured by arranging two magnets. It may also be possible to configure one “magnetic pole formation portion” by combining a plurality of magnets and form the “magnetic pole body” of a combination of such “magnetic pole formation portions”.

In the foregoing embodiment, each of the magnets 61 to 64 is formed in generally the same square shape as the traverse section of each of the coils 41 to 44. However, the shape, the lengths of the sides, and the like of each of the magnets may also be changed as required, as long as each of the magnets has a quadrilateral shape proximate to each of the coils. For example, each of the magnets may also be formed in a rectangular shape. Also, the sides of each of the magnets may also be slightly inclined relative to the individual axis directions. In addition, the corner portions of each of the magnets may have arc shapes as in the foregoing embodiment or may also be chamfered. Also, each of the magnets may also be partially cut away to avoid interference with the housing or the like.

In the foregoing embodiment, each of the magnets 61 to 64 is held on the movable yoke 72 such that the respective sides 69 of the facing surfaces 68 adjoin each other. However, minute gaps may also be formed between the individual arranged magnets.

In the foregoing embodiment, each of the coils 41 to 44 is square in traverse section. However, the shape of each of the coils may also be changed as required. For example, each of the coils may also be formed in a rectangular traverse sectional shape. It may also be possible that, in a crisscross arrangement, the coils arranged in the x-axis direction and the coils arranged in the y-axis direction have different shapes. In each of the coils, the number of windings of the winding wire, the diameter of the wire, and the like may also be changed as required. Also, in each of the coils, the winding wire portion extending in each of the axis directions need not be perfectly linear, but may be slightly curved.

In the foregoing embodiments, the full stroke amount St_x in the x-axis direction and the full stroke amount St_y in the y-axis direction are set equal. However, these full stroke amounts may also be different from each other. In addition, the stroke amount in the forward direction from the reference position and the stroke amount in the rearward direction from the reference position may also be different from each other. Likewise, the stroke amount in the leftward direction from the reference position and the stroke amount in the rightward direction from the reference position may also be different from each other. That is, the center of the magnet combination that has returned to the reference position may also be located off the center of the center region.

In the foregoing embodiment, the lengths d_x and d_y of the center region in the individual axis directions are defined as values obtained by adding double of the thickness tc of h the winding wire 49 to the full stroke amounts St_x and St_y in the individual axis directions. However, it may also be ensured that the lengths d_x and d_y of the center region in the individual axis directions are exactly the full stroke amounts St_x and St_y in the individual directions. If it is possible to bring the individual coils closer to each other while avoiding interference between the individual coils, the center region may further be narrowed.

In the foregoing embodiment, the input device 100 is mounted in the vehicle with the direction of the operation plane OP defined by the operation knob 70 being along the horizontal direction of the vehicle. However, the input device 100 may also be attached to the center console or the like of the vehicle with the operation plane OP being inclined relative to the horizontal direction of the vehicle.

In the foregoing embodiment, the allowance length ml_x in the x-axis direction is set substantially the same as the stroke amount in the leftward direction such that, when, e.g., the magnet combination 60 is maximally moved in a specified direction, e.g., the leftward direction (see FIG. 7), the magnets 63 and 64 do not overlap the winding wire portion of the coil 43 which forms the outer edge 46a. However, the allowance length ml_x in the x-axis direction may also be set sufficiently larger than the stroke amount in the leftward or rightward direction. Likewise, the allowance length ml_y in the y-axis direction may also be set sufficiently larger than the stroke amount in the forward or rearward direction.

In the foregoing embodiment, the effective length el_y in the y-axis direction is set substantially the same as the stroke amount in the forward direction such that, when, e.g., the magnet combination 60 is maximally moved in a specified direction, e.g., the forward direction (see FIG. 8), the magnets 62 and 63 do not get away from the winding wire portion of the coil 42 which forms the inner edge 47b. However, as long as a length required to generate an operation reaction force is ensured, the effective length el_y in the y-axis direction may also be set shorter than the stroke amount in the forward or rearward direction. Likewise, as long as a length required to generate the operation reaction force is ensured, the effective length el_x in the x-axis direction may also be set shorter than the stroke amount in the leftward or rightward direction.

In the foregoing embodiment, each of the coils 41 to 44 is held on the circuit board 52. However, the component which holds each of the coils is not limited to the circuit board. For example, the housing or the like may also directly hold each of the coils. The component which holds each of the magnetic heads 61 to 64 is also not limited to the movable yoke 72 as used in the foregoing embodiment, but may be modified as required.

In the foregoing embodiment, the function provided by the operation controller 33 and the reaction force controller 37 may also be provided by hardware and software different from those described above or a combination of hardware and software different from those described above or a combination thereof. For example, the function may also be provided by an analog circuit which performs a predetermined function without using a program.

The foregoing embodiment has described an example in which the present disclosure is applied to the input device 100 placed at the center console as a remote operation device for operating the navigation device 20. However, the present disclosure is applicable to a selector such as a shift lever placed at the center console, a steering switch provided at a steering wheel, or the like. The present disclosure is also applicable to an instrument panel, a window-side arm rest provided at a door or the like, or various vehicular functional operation devices provided in the vicinity of a rear seat or the like. The input device to which the present disclosure is applied is not limited to vehicular applications, but is applicable to operation systems in general used for various transportation devices, various information terminals, or the like.

What is claimed is:

1. An input device to which an operation force in a direction along a virtual operation plane is inputted, the input device comprising:
four coil bodies each including a winding wire to which a current is applied, wherein the winding wire of each coil body is wound to form four sides extending in an x-axis direction and a y-axis direction each along the operation plane;
a holder holding the coil bodies such that the coil bodies are arranged two by two in the x-axis and y-axis directions and are arranged in a crisscross with a center region and four sides of the center region are surrounded by the four coil bodies;
four magnetic pole formation portions each having a quadrilateral shape, wherein the quadrilateral shape of each magnetic pole formation portion is proximate to or substantially the same as a shape of each coil body, wherein each magnetic pole formation portion has a facing surface that faces two of the four coil bodies in a winding axis direction of the winding wire, wherein the four magnetic pole formation portions are arranged two by two in the x-axis and y-axis directions such that the facing surfaces have alternate polarities, wherein electromagnetic forces are generated between the four magnetic pole formation portions and the coil bodies when the currents are applied to the winding wires; and
a movable body holding the four magnetic pole formation portions so as to form predetermined gaps between the facing surfaces and the coil bodies, wherein the movable body is arranged to be movable relative to the holder in response to receipt of the operation force.

2. An input device to which an operation force in a direction along a virtual operation plane is inputted, the input device comprising:
four coil bodies each including a winding wire to which a current is applied, wherein each winding wire is wound to form four sides extending in an x-axis direction and a y-axis direction each along the operation plane;
a holder holding the coil bodies such that the coil bodies are arranged two by two in the x-axis and y-axis directions and are arranged in a crisscross with a center region, wherein four sides of the center region are surrounded by the four coil bodies;
four magnetic pole formation portions each having a facing surface that faces two of the four coil bodies in a winding axis direction of the winding wire, wherein the magnetic pole formation portions are arranged two by two in the x-axis and y-axis directions such that the facing surfaces have alternate polarities, wherein electromagnetic forces are generated between the coil bodies and the magnetic pole formation portions when current applied to the winding wires; and
a movable body holding the four magnetic pole formation portions such that predetermined gaps are formed between the facing surfaces and the coil bodies, wherein the movable body is arranged to be movable relative to the holder in response to receipt of the operation force,
wherein,
the four magnetic pole formation portions constitute a magnetic pole body,
a maximum length of the magnetic pole body along the y-axis is defined as a y-axis direction length of the magnetic pole body,
a maximum length of the magnetic pole body along the y-axis is defined as a y-axis direction length of the magnetic pole body,
the coil bodies include a pair of coil bodies arranged in the x-axis direction,
a specific side of the four sides of each coil body in the pair of coil bodies arranged in the x-axis direction is a side that extends in the y-axis direction and that is most distant from the center region among the four sides,
a maximum distance between the specific side of one coil body in the pair of coil bodies arranged in the x-axis direction and the specific side of the other coil body in the pair of coil bodies arranged in the x-axis direction is defined as a distance between outer edges in the x-axis direction,
the coil bodies include a pair of coil bodies arranged in the y-axis direction,
a specific side of the four sides of each coil body in the pair of coil bodies arranged in the y-axis direction is a side that extends in the x-axis direction and that is most distant from the center region among the four sides,
a maximum distance between the specific side of one coil body in the pair of coil bodies arranged in the y-axis direction and the specific side of the other coil body in the pair of coil bodies arranged in the y-axis direction is defined as a distance between outer edges in the y-axis direction,
the x-axis direction length of the magnetic pole body is shorter than the distance between the outer edges in the x-axis direction, and
the y-axis direction length of the magnetic pole body is shorter than the distance between the outer edges in the y-axis direction.

3. The input device according to claim 2, wherein
each facing surface has a quadrilateral shape, and
the quadrilateral shape of the facing surface is proximate to or substantially the same as a shape of each coil body.

4. The input device according to claim 1, wherein
each side of each facing surface is along the x-axis or the y-axis.

5. The input device according to claim 1, wherein,
a distance over which the four magnetic pole formation portions are bidirectionally movable along the x-axis is defined as a full stroke amount in the x-axis direction,
it is ensured that a length of each magnetic pole formation portion in the x-axis direction is greater than or equal to a total sum of: half of the full stroke amount in the x-axis direction; double of a thickness of the winding wire; and an effective length in the x-axis direction, and
the effective length is a predefined length of a range in which an x-axis extending portion of the winding wire overlaps the magnetic pole formation portion.

6. The input device according to claim 1, wherein,
a distance over which the four magnetic pole formation portions are bidirectionally movable along the y-axis is defined as a full stroke amount in the y-axis direction,
it is ensured that a length of each magnetic pole formation portion in the y-axis direction is greater than or equal to a total sum of: half of the full stroke amount in the y-axis direction; double of the thickness of the winding wire; and an effective length in the y-axis direction, and
the effective length in the y-axis direction is a predefined length of a range in which a y-axis direction extending portion of the winding wire overlaps the magnetic pole formation portion.

7. The input device according to claim 1, wherein
sides of the facing surfaces of adjacent ones of the adjacent magnetic pole formation portions adjoin each other.

8. The input device according to claim 1, wherein
the four magnetic pole formation portions have a predefined reference position to which the four magnetic pole formation portions are to be returned in response to release of the operation force to the movable body.

9. The input device according to claim 8, wherein
a distance over which the four magnetic pole formation portions are movable from the reference position in a specified direction along the x-axis or the y-axis is defined as a stroke amount in the specified direction,
the coil bodies includes a pair of coil bodies arranged in the specified direction,
a specific winding wire is a winding wire of one coil body in the pair of coil bodies arranged in the specified direction,
the one coil body in the pair of coil bodies arranged in the specified direction is located in the specified direction than the other coil body in the pair of coil bodies arranged in the specified direction, and
it is ensured that, in a state where the four magnetic pole formation portions are located at the reference position, a length of a portion of the specific winding wire that extends in the specified direction and protrudes from the magnetic pole formation portions is greater than or equal to the stroke amount in the specified direction.

10. The input device according to claim 8 or 9, wherein
a distance over which the four magnetic pole formation portions are movable from the reference position in the specified direction along the x-axis or the y-axis is defined as a stroke amount in the specified direction,
the coil bodies includes a pair of coil bodies arranged in the specified direction,
a specific winding wire is a winding wire of one coil body in the pair of coil bodies arranged in the specified direction,
the other coil body in the pair of coil bodies arranged in the specified direction is located in the specified direction than the one coil body in the pair of coil bodies arranged in the specified direction, and
it is ensured that, in a state where the four magnetic pole formation portions are located at the reference position, a length of a portion of the specific winding wire that extends in the specified direction and protrudes from the magnetic pole formation portions is greater than or equal to the stroke amount in the specified direction.

11. The input device according to claim 1, wherein
the coil bodies includes a pair of coil bodies arranged in the x-axis direction, and
it is ensured that a length of a y-axis direction extending portion of each coil body in the pair of coil bodies arranged in the x-axis direction is greater than or equal to the distance over which the four magnetic pole formation portions are bilaterally movable along the y-axis.

12. The input device according to claim 1, wherein
the coil bodies includes a pair of coil bodies arranged in the y-axis direction, and
it is ensured that a length of an x-axis direction extending portion of each coil body in the pair of coil bodies arranged in the y-axis direction is greater than or equal to the distance over which the four magnetic pole formation portions are bilaterally movable along the x-axis.

13. The input device according to claim 1, wherein
it is ensured that a length of the center region in the x-axis direction is greater than or equal to the distance over which the four magnetic pole formation portions are bilaterally movable along the x-axis.

14. The input device according to claim 1, wherein
it is ensured that a length of the center region in the y-axis direction is greater than or equal to the distance over which the four magnetic pole formation portions are bilaterally movable along the y-axis.

15. The input device according to claim 2, wherein
each side of each facing surface is along the x-axis or the y-axis.

16. The input device according to claim 2, wherein,
a distance over which the four magnetic pole formation portions are bidirectionally movable along the x-axis is defined as a full stroke amount in the x-axis direction,
it is ensured that a length of each magnetic pole formation portion in the x-axis direction is greater than or equal to a total sum of: half of the full stroke amount in the x-axis direction; double of a thickness of the winding wire; and an effective length in the x-axis direction, and
the effective length is a predefined length of a range in which an x-axis extending portion of the winding wire overlaps the magnetic pole formation portion.

17. The input device according to claim 2, wherein,
a distance over which the four magnetic pole formation portions are bidirectionally movable along the y-axis is defined as a full stroke amount in the y-axis direction,
it is ensured that a length of each magnetic pole formation portion in the y-axis direction is greater than or equal to a total sum of: half of the full stroke amount in the y-axis direction; double of the thickness of the winding wire; and an effective length in the y-axis direction, and
the effective length in the y-axis direction is a predefined length of a range in which a y-axis direction extending portion of the winding wire overlaps the magnetic pole formation portion.

18. The input device according to claim 2, wherein
sides of the facing surfaces of adjacent ones of the adjacent magnetic pole formation portions adjoin each other.

19. The input device according to claim 2, wherein
the four magnetic pole formation portions have a predefined reference position to which the four magnetic pole formation portions are to be returned in response to release of the operation force to the movable body.

20. The input device according to claim 19, wherein
a distance over which the four magnetic pole formation portions are movable from the reference position in a specified direction along the x-axis or the y-axis is defined as a stroke amount in the specified direction,
the coil bodies includes a pair of coil bodies arranged in the specified direction,
a specific winding wire is a winding wire of one coil body in the pair of coil bodies arranged in the specified direction,
the one coil body in the pair of coil bodies arranged in the specified direction is located in the specified direction than the other coil body in the pair of coil bodies arranged in the specified direction, and
it is ensured that, in a state where the four magnetic pole formation portions are located at the reference position, a length of a portion of the specific winding wire that extends in the specified direction and protrudes from the magnetic pole formation portions is greater than or equal to the stroke amount in the specified direction.

21. The input device according to claim 19, wherein
a distance over which the four magnetic pole formation portions are movable from the reference position in the specified direction along the x-axis or the y-axis is defined as a stroke amount in the specified direction,
the coil bodies includes a pair of coil bodies arranged in the specified direction,
a specific winding wire is a winding wire of one coil body in the pair of coil bodies arranged in the specified direction,
the other coil body in the pair of coil bodies arranged in the specified direction is located in the specified direction than the one coil body in the pair of coil bodies arranged in the specified direction, and
it is ensured that, in a state where the four magnetic pole formation portions are located at the reference position, a length of a portion of the specific winding wire that extends in the specified direction and protrudes from the magnetic pole formation portions is greater than or equal to the stroke amount in the specified direction.

22. The input device according to claim 2, wherein
the coil bodies includes a pair of coil bodies arranged in the x-axis direction, and
it is ensured that a length of a y-axis direction extending portion of each coil body in the pair of coil bodies arranged in the x-axis direction is greater than or equal to the distance over which the four magnetic pole formation portions are bilaterally movable along the y-axis.

23. The input device according to claim 2, wherein
the coil bodies includes a pair of coil bodies arranged in the y-axis direction, and
it is ensured that a length of an x-axis direction extending portion of each coil body in the pair of coil bodies arranged in the y-axis direction is greater than or equal to the distance over which the four magnetic pole formation portions are bilaterally movable along the x-axis.

24. The input device according to claim 2, wherein
it is ensured that a length of the center region in the x-axis direction is greater than or equal to the distance over which the four magnetic pole formation portions are bilaterally movable along the x-axis.

25. The input device according to claim 2, wherein
it is ensured that a length of the center region in the y-axis direction is greater than or equal to the distance over which the four magnetic pole formation portions are bilaterally movable along the y-axis.
